(19) United States
(12) Patent Application Publication
(10) Pub. No.: US 2026/0109544 A1
(43) Pub. Date: Apr. 23, 2026

(54) RIBLESS POSITIVE DRIVEN SPIRAL SYSTEM WITH POINTED OR ROUNDED END TRANSITION ELEMENTS

(71) Applicant: Ashworth Bros., Inc., Fall River, MA (US)

(72) Inventor: Ricardo Pio Barakat Biscioni, Sao Paulo (BR)

(21) Appl. No.: 19/361,869

(22) Filed: Oct. 17, 2025

Related U.S. Application Data
(60) Provisional application No. 63/708,330, filed on Oct. 17, 2024.

(51) Int. Cl. B65G 17/38; B65G 17/08; B65G 23/06

(52) U.S. Cl. CPC B65G 17/385; B65G 17/083; B65G 17/086; B65G 23/06; B65G 2207/24

(57) ABSTRACT

A spiral conveyor system including a conveyor belt formed of a plurality of links joined by a plurality of connecting rods forming a plurality of belt segments; and a drum formed generally as a cylinder having a central longitudinal axis coaxial, the drum defining a helical path for the conveyor belt and an outer boundary, wherein the drum is configured to rotate around the central longitudinal axis and to releasably interact with each of the plurality of belt segments at the outer boundary. The belt moves along the helical path in response to the sequential interaction between the drum outer boundary and the belt segments as the drum rotates; and the drum includes a plurality of tapered transition elements configured to facilitate engagement of the belt with the drum.

### CROSS-REFERENCE TO RELATED APPLICATIONS

This application claims priority to U.S. Provisional Application No. 63/708,330, filed Oct. 17, 2024, and entitled “Ribless Positive Driven Spiral System with Pointed or Rounded End Transition Elements,” the entire disclosure of which is incorporated herein by reference.

### BACKGROUND

### Technical Field

The disclosures herein relate to direct-driven spiral belt systems. Specifically, the disclosed invention relates to a ribless drive system with pointed or rounded transition element ends. In some embodiments, the transition elements may protrude beyond an outward facing surface of the drum infeed ring for easing onboarding of the spiral belt on the ribless drive caps. In other embodiments the transition elements may be flush with the outward facing surface of the ring. In still other embodiments, the transition elements may be recessed radially inward from the outward facing surface of the ring. In some embodiments, the transition elements are tapered so the belt tension is reduced after initial engagement with the drum. In addition, the transition elements may be configured in parallel or aligned to the long ribless drive caps of the direct drive drum.

### State of the Art

Spiral conveyor belt systems enjoy widespread use in the manufacturing and commercial food processing industries. A spiral system is, essentially, a conveyor belt that moves in a corkscrew-shaped path to vertically transit items on the belt along a lengthened helical path. This is useful to move parts through a process across different vertical levels using a small footprint. Spiral belts create a long path within a small space, and thus, they are used to move food products through a cooler or oven to freeze, cool, or cook food products during a lengthier time frame. The helical configuration used by a spiral system can accommodate hundreds of meters of belt path within a relatively small floor area.

The conveyor belt encircles a rotating drum. The drum may present an essentially unbroken surface or may be formed from a series of vertically oriented bars spaced apart at intervals in a cage assembly. The drum engages the belt along the inner radius of the belt's helical path to move it forward. In some systems, this is accomplished by simple friction between the drum/cage and the inner-radius edge of the belt, as described in U.S. Pat. No. 3,348,659, for example. In other systems, a feature known as a “cage bar cap,” often made from plastic and coupled to vertical profiles of the drum cage structure, engages with a corresponding feature on the inner belt radius, typically one of the protruding horizontal belt rods, as described in U.S. Pat. No. 4,932,925, for example. Traction elements of a spiral system may additionally include a central cage, sprockets at the outside links of the belt, or even a drive chain disposed on the underside of a self-stacking belt.

Powered rotation of the drum moves the belt along the helical path. A secure but releasable coupling between the drum outer surface, which may be a cage bar, and the inner edge of the belt is essential for proper function of any spiral conveyor belt system.

Drum surfaces of ribbed direct drive systems as described on US 2019/0389663 A1 and U.S. Pat. No. 11,014,751 B2 are difficult to clean due to the quantity of corners, ribless direct drive systems have advantages over prior art spiral systems. They provide a stronger engagement of the belt to the drum since ribs may suffer deflection with application of high load. The rib portion that initially engages the belt on designs where the rib is protruding beyond the face on which the belt enters the spiral wears faster, whereas ribless designs deliver longer lasting components and a more hygienic system, which is highly desirable in the food industry and other applications where contamination is critical. However, initial engagement of the belt to a ribless drum has to be smooth to avoid movement of products being conveyed. Positive/direct driven spiral systems have the advantage of a more stable operation compared to friction driven spirals. Since the belt travels mechanically connected to the cage bar caps, sliding upwards or downwards depending on the system configuration, instead of sliding forwards/backwards on the cage due to the overdrive required for proper operation of friction driven systems, some small belt movement still takes place in positive/direct drive spirals, especially when the belt is initially onboarding the drum before the final engagement to the long cage bar caps. A design that minimizes such movement and cleanly engages the belt to a ribless drum is preferable for product stability being conveyed and less components wearing. Such a design is the scope of this disclosure.

For at least the foregoing reasons, there is a need for a spiral conveyor drive system that addresses the issues discussed herein above.

### BRIEF SUMMARY

Disclosed herein are embodiments of a spiral conveyor belt system. Embodiments of the system allow for smoother transfer of the belt to the ribless drum by the usage of protruded or pointed transition elements on the top of an infeed ring. In some embodiments an infeed ring is not used. In part, the disclosures relate to pointed or rounded transition elements which may be configurated in between the long ribless cage bar caps or vertically aligned to them. Since these elements have a pointed end which is protruding beyond an outer facing surface of the ring, the belt tabs can smoothy slide upwards in order to engage the transition elements and then the long ribless cage bar caps. In some embodiments, the pointed elements may not protrude beyond the outer facing surface of the ring, and instead may be flush with the outer facing surface of the ring or recessed inward from the outer facing surface of the ring. The pointed or rounded ends may be formed with a chamfer at the trailing edge or at the leading edge of the transition elements. In some embodiments, one or more of the pointed or rounded ends may have a chamfer at both the trailing edge and leading edge. In some embodiments where the pointed component is aligned with the long ribless cage bar caps, the cage bard cap and pointed component may be made of separate parts. In other embodiments the cage bar cap and pointed component may both be part of the same unitary piece of material. For example, both components may be part of a one-piece extruded cap which is later machined to taper as desired, with the end of the pointed/rounded element being chamfered to create the pointed end. Embodiments with separate components may be manufactured with the same material or different materials, for example Nylon could be used for the transition elements and a different type of plastic may be used for the long and more costly cage bar caps. It will be understood, however, that any suitable combination of materials is possible to extend components life and match application requirements.

Disclosed is a drum formed generally as a cylinder having a central longitudinal axis coaxial with the helical path and an outer boundary, wherein the drum is configured to rotate around the central longitudinal axis and to releasably interact with each of the plurality of belt segments at the outer boundary; wherein the belt moves along the helical path in response to the sequential interaction between the drum outer boundary and the belt segments as the drum rotates.

In some embodiments, the drum sequentially interacts with the belt segments by mechanical engagement with a belt rod inner end or a belt link tab. In some embodiments, the drum releasably engages with the inner edge of the belt. In some embodiments, the drum comprises a plurality of bars disposed around the outer boundary, each bar configured to releasably engage with a plurality of belt rod inner ends simultaneously. In some embodiments, the long drive caps are ribless.

In some embodiments, the drum further comprises an infeed and an outfeed, wherein the infeed and the outfeed are disposed on the outer boundary at separate axial locations, wherein the interaction between the drum and the belt segments occurs along a length of the drum central longitudinal axis beginning at the infeed and terminating at the outfeed. The belt may have a first radius extending between the longitudinal axis of the drum and the outer boundary of the drum between the infeed and the outfeed. In addition, the belt may have a second radius extending between the longitudinal axis of the drum and the outer boundary of the drum at one or both of the infeed and the outfeed. The drum may include a ramp disposed on the outer boundary, wherein the second radius is greater than the first radius, the second radius transitioning to the first radius along the ramp, and wherein the ramp is configured to move the belt inward from the second radius to the first radius beginning at the infeed and outward from the first radius to the second radius ending at the outfeed. Tapering of the transition elements enables the belt to go from a bigger cage diameter to a smaller cage diameter, thus having its tension reduced. Usually, the tapered area is associated with at least the first tier of the spiral system.

In one aspect, the present disclosure is directed to a spiral conveyor system. The system may include a conveyor belt formed of a plurality of links joined by a plurality of connecting rods forming a plurality of belt segments; and a drum formed generally as a cylinder having a central longitudinal axis coaxial, the drum defining a helical path for the conveyor belt and an outer boundary, wherein the drum is configured to rotate around the central longitudinal axis and to releasably interact with each of the plurality of belt segments at the outer boundary. The belt moves along the helical path in response to the sequential interaction between the drum outer boundary and the belt segments as the drum rotates; and the drum includes a plurality of tapered transition elements configured to facilitate engagement of the belt with the drum.

The features and advantages of the invention will be apparent to those of ordinary skill in the art from the following more particular description of several example embodiments of the disclosed system and methods, and the accompanying drawings.

### BRIEF DESCRIPTION OF THE DRAWINGS

FIG. 1 is a perspective view of an example prior art spiral conveyor system;

FIG. 2 is a perspective view of an example of tapered transition elements in a prior art positive/direct drive system;

FIG. 3 is a perspective top view illustration of a group of tapered cage bar caps disposed around a perimeter of a drive drum;

FIG. 4 is a perspective view of a drum of a spiral conveyor system;

FIG. 5 is a diagram of a drum in a spiral conveyor system moving a belt in a helical path;

FIG. 6 is a view of the protruding and pointed parallel transition elements at 1:1 ratio to the long ribless caps;

FIG. 7 is a lateral view of the protruding and pointed transition elements;

FIG. 8 is a view of the belt at the infeed ring before engagement to the transition elements;

FIG. 9 is a perspective bottom view of the cage (drum) shown in FIGS. 6-8;

FIG. 10 is a perspective view of the transition elements aligned with the long ribless cage bar caps instead of in parallel;

FIG. 11 is a perspective view of the protruding and pointed transition elements with a chamfer at the trailing edge only;

FIG. 12 is a perspective view of the belt close to the end of the pointed cap, long cage bar caps not shown;

FIG. 13 is a view of the belt in contact with the pointed cap ends;

FIG. 14 is a perspective view of the belt at different levels along the spiral path (infeed ring, parallel transition element, ribless long cap and outfeed ring);

FIG. 15 is a perspective view of the drum structure composed of inner rings, short bars and long bars;

FIG. 16 is a top view of the cage structure;

FIG. 17A is a perspective view of a pointed transition element integrated with a long cage bar cap, the tip having a chamfer at both sides;

FIG. 17B is a perspective view of a pointed transition element integrated with a long cage bar cap, the tip having a chamfer at one side only;

FIG. 18 is a top view of a drive system alternating pointed transition elements and long cage bar caps, with an infeed ring and inner ring shown;

FIGS. 19A and 19B are enlarged perspective views of transition elements with sharp pointed ends;

FIG. 20 is a perspective view of a transition element with a rounded end and chamfer at a leading edge;

FIGS. 21A and 21B are front views of transition elements with pointed and rounded ends and chamfers at both the trailing edge and leading edge;

FIG. 22 is a view of the interaction of the link tab with the end of the transition element when the belt is initially engaging the transition element;

FIG. 23 is a view of an embodiment of pointed transition elements without an infeed ring and plate attachments;

FIG. 24 is an enlarged view (compared to that of FIG. 23) of the belt interacting with the bottom of the wider transition elements;

FIG. 25 is a view of the interaction between a belt tab and a pointed transition element with chamfers at both the leading and trailing edges.

### DETAILED DESCRIPTION

Various example embodiments of a spiral conveyor system are discussed herein. The system includes a drum with its structural inner rings, long cage bars, short cage bars and correspondent cage bar caps, the cage bars may be flat bars, square tubing or any structural element for receiving cage bar caps. Embodiments of the system have advantages over existing spiral conveyor systems, including, for example, a smoother transfer for the belt to onboard the transition elements and the long drive caps.

Details of a spiral conveyor system with direct drum engagement are first discussed generally, followed by descriptions with reference to the several drawing figures. It is conceived that the concept of providing a ribless spiral conveyor system with direct drum engagement which may enable a smooth belt transfer when entering the system and the benefits associated therewith is within the scope of these disclosures. The utility of such a system as disclosed herein, not merely with the disclosed embodiments but across a range of cage bar cap designs will be immediately appreciated by one of skill in the art.

### Definitions

As used herein, “cage” refers to a drum component mechanically interacting with a belt, causing movement of the belt along a helical path. “Cage drive” is a type of drum. The cage drive is generally configured as an array of vertical elements, such as cage bars, for example, extending between two generally circular end elements forming a generally cylindrical cage-like structure. In some embodiments, the circular end elements may each have the same radius. In other embodiments, the circular end elements may have different radii, whereupon the drum itself has a frustrum shape with either a decreasing radius or an increasing radius from a drum bottom end element to a drum top end element. For embodiments in which the end elements have different radii, a generally tapered cylindrical cage may be formed.

As used herein, “tier” means a complete turn of the belt around the drum, basically the distance between belt levels around the spiral path.

As used herein, “belt” means an elongated, continuous, flexible structure formed from a plurality of links coupled together with a plurality of bars oriented orthogonal to the links. In some embodiments, the belt includes a mesh or wire grid providing a surface upon which product transported by the spiral conveyor system rests. “Belt” encompasses all structures and substructures moving along a helical path. “Belt” is used loosely in certain disclosures herein to refer to a limited length of an entire belt structure.

As used herein, “cage bar” means a generally elongated structure forming part of the drum structure or disposed upon the surface of a belt drive drum. The cage bar is part of the drive drum assembly and not part of the belt. A cage bar interacts with an inner belt edge by way of a “bar cap” or “cage bar cap” mounted on the bar. In some embodiments, the cage bar may be machined similar to a cage bar cap, and thus, the cage bar itself may be configured to interact directly with the belt without using plastic caps. In some cases, this feature may be applied in oven applications for example, where high temperature may impair the use of plastics on the drum's surface.

As used herein, “link” means a structure disposed along one of the edges (inner edge and outer edge) of a belt. The link is part of the belt. Each single link is coupled to two adjacent links—one forward link and one trailing link with respect to the direction of belt travel—by two support rods. In some embodiments, the link may be coupled to the two adjacent links with three support rods.

As used herein “cage bar cap” means a structure, usually made of plastic, mounted on a cage bar and configured to frictionally or mechanically interact with a belt edge. The cage bar cap is the point of coupling between the drive drum and the belt. The cage bar cap can be formed in many different configurations to interact with the belt edge in different ways, many examples of which are described herein.

As used herein, a “rib,” “ridge,” “cage rib,” or “bar cap rib” is a structure disposed on the outer surface (i.e., belt inner edge-facing surface) of a cage bar or cage bar cap. The rib protrudes from the outer surface of the cage bar or cage bar cap and interfaces with the belt inner edge. A “ribless system” or a “ribless cage bar” does not comprise ribs; i.e., the drive drum does not engage with the belt inner edge by means of a protruding structure, but rather the caps engage by means of a non-protruding structure, using its existent leading sides for example, usually but not necessarily perpendicular to the front side.

As used herein, “system turn ratio” means the ratio between the radius traveled by the inner belt edge along a helical path (i.e., the distance from the inner belt edge to the central axis of the helical path) and the belt width.

As used herein, “inner edge and outer edge” are related to the belt moving in a path tracing a helix having an inner radius and an outer radius. The outer-edge of the belt moves in a similar helical path having an outer radius. Otherwise stated, the inner radius is the linear distance from a central axis of rotation of the drive drum to the inner belt edge. The outer radius is the corresponding linear distance from the central axis of rotation of the drive drum to the outer belt edge. The outer radius of the belt helical path (belt outer edge) is inherently larger than the inner radius of a belt helical path.

As used herein, a “positive drive system,” “direct drive system,” or “positive driven system” refers to a belt system wherein there is direct mechanical engagement between a cage bar or cage bar cap feature and a corresponding feature on the belt, such as a support rod end or tab, for example. This is in contrast to a friction-drive system wherein such contact between complementary features on the cage drive and the belt is by accomplished friction.

As used herein, “transition elements” are related to tapered components that initially contact the belt inner edge and lead the belt to the long caps to be driven along the spiral path. In many embodiments, the transition elements may be covered by plastic caps, although they may be part of the metal structure of the drum in some oven applications. The transition elements may be small compared to the height of the overall spiral system, usually about 1 spiral tier height. It will be appreciated that the size of the transition elements may vary depending on how much decrease of belt tension is intended. It will be further appreciated that the taper angle of the transition element may also vary.

Spiral conveyor systems may be friction-driven or driven by mechanical engagement between the cage drive and a feature presented by the conveyor belt, as described in the Background section herein above. In some applications, a friction drive, whereunder the drum engages with the belt to cause movement merely by friction with an edge of the belt, is advantageous where some backward slippage of the belt on the drum may be desirable for proper operation. In other applications, however, slippage between the drum and the belt is not desirable and direct mechanical engagement between a feature of the belt and a corresponding feature on drum drive cage is required. Consequently, a spiral conveyor system utilizing direct engagement between the drive cage and the conveyor belt is disclosed. It will be understood, however, that the present configurations of transition elements could be implemented with a friction drive systems.

Some advantages of a smoother transfer from the belt to the ribless cage bar caps are less belt chattering, less movement of the product being conveyed, and less wear of system components.

In some embodiments discussed herein, the cage bar cap or cage bar sides may be angled (not radially aligned with the drive cage central axis of rotation).

In some spiral belt systems, the engagement between the cage bar caps and the belt features is configured to permit belt travel around a cage drive with changing helical diameter, as with a tapered cage drive. This is known in the art as “beveling” or “tapering.” Where the belt travels along a helical path starting from a larger radius that becomes progressively smaller until the belt exits the helix, belt tension is reduced along the helical path.

In some embodiments, the belt engages the cage drive by means of belt bar inner ends which may be either orthogonal or angled with respect to a direction line tangent to the helical path.

Prior art ribless drum designs for positive drive systems have several advantages over ribbed designs, however a smooth transfer for the belt entering the system is essential for proper functioning of the system, abrupt backwards, inwards, or outwards movement of the belt inner edge to final engagement is undesirable.

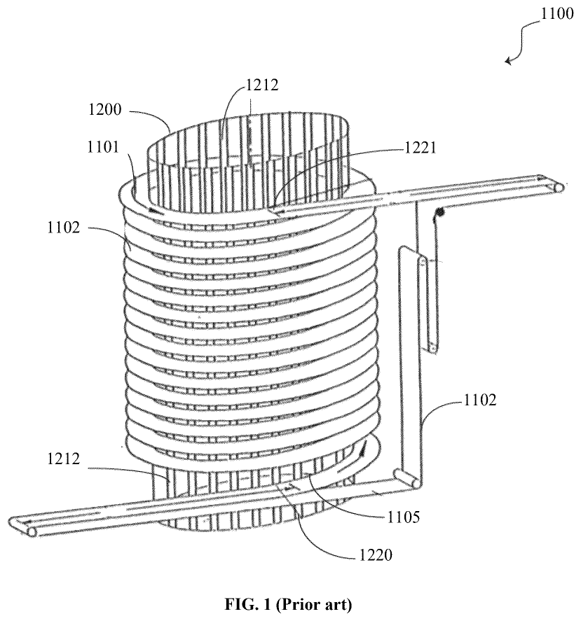

FIG. 1 is a perspective view of an example prior art spiral conveyor system; it shows a prior art system 1100 comprising a belt 1102 engaged with a drum 1200 along a helical path shown by the arrow labeled 1101. Engagement of belt 1102 with drum 1200 begins at an infeed 1220 and terminates at an outfeed 1221, as shown. The prior art system shown in FIG. 1 depicts aspects common to all spiral conveyor systems. Thus, it will be understood that the embodiments disclosed herein will generally be implemented on spiral conveyor systems having the basic features shown and described with respect to system 1100 in FIG. 1. The belt translates vertically along a helical path, moved by a rotating drum that engages with the belt at a plurality of locations where a belt inner edge 1105 contacts cage bars 1212. Belt 1102 may be moved in either direction, as depicted by the arrows in FIG. 1, depending on the direction of rotation of drum 1200. The example of cage drum 1200 shown in FIG. 1 has an ovoid cross section. In practice, existing drums may be circular, ovoid, or tapering in cross section, depending on the application wherein the spiral belt system is used. Accordingly, the embodiments disclosed herein are not intended to be limited to any particular drum shape and are offered by example only.

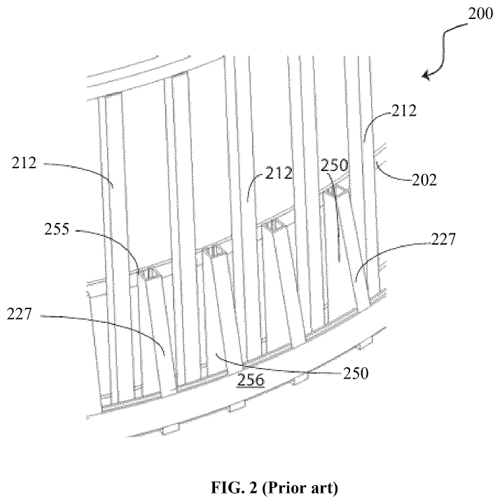

FIG. 2 is a perspective view of an example of prior art which shows tapered transition elements disposed around a perimeter of a drive drum and connected to the infeed ring 256 and inner drum ring 202. FIG. 2 shows a plurality of cage bar caps 212 in a circular arrangement, each as they would be mounted on a cage bar of drum 200, in some embodiments. An outer boundary of drum 200 is shown and is defined by the outermost surfaces of the plurality of cage bar caps 212. Long cage bars, short cage bars, and inner rings 202 are considered a substructure of drum 200. As can be seen, to enter this prior art system a belt would need to first collapse onto the ring, move upwards and then inwards to engage the transition elements. In contrast, the embodiments of the presently disclosed embodiments do not require the inward movement for the transition ring-transition element since the transition element is protruding beyond the outer facing surface of the ring. Rather, the belt can smoothly slide upwards and connect, thus providing a smoother transfer.

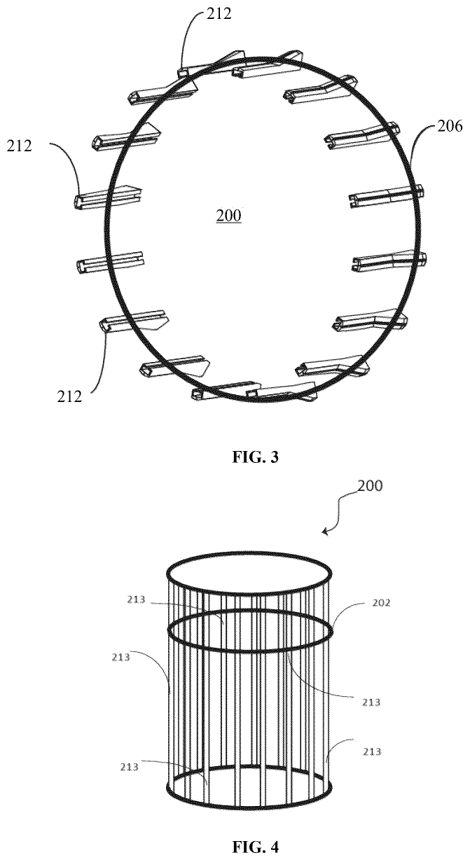

FIG. 3 is a perspective top view of a plurality of tapered cage bar caps. As shown in FIG. 3, a plurality of cage bar caps 212 include a plurality of outer facing surfaces facing radially outward, and which collectively form an outer boundary 206 of the drum 200.

FIG. 4 is a perspective view of a drum of a spiral conveyor system. In some embodiments, as shown in FIG. 4, a drum 200 having an array of bars 213 may form a structure with the appearance of a cylindrical cage. Accordingly, such embodiments of drum 200 are also referred to as a “cage drum” and bar 213 is also referred to as a “cage bar.” In some embodiments, an elongate bar cap 212 (omitted for clarity and not shown in FIG. 4) is coupled to each cage bar 213 providing a feature for interacting with inner edge 1105 of belt 1102 (see FIG. 1). Cage ring 202 is also shown and is disposed around drum 200 encircling bars 213 to hold them in a circular arrangement.

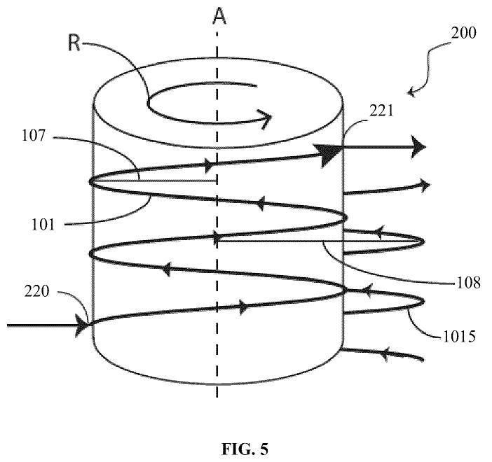

In the embodiments shown in FIG. 5, the belt moves up or down drum 200 contacting the tapered bar cap 212 (see FIG. 3) along the belt inner edge. Helical path 101 is traced as the belt wraps around drum 200 in multiple levels or tiers stacked upon one another, such as can be seen in FIG. 1, for example. Embodiments of a system incorporating the tapered bar cap 212 (shown in FIG. 3, e.g.) comprise a changing inside radius 107 from tier-to-tier across drum 200 created by the tapered outer surface of bar cap 212. Radius 107 may decrease across the belt tiers from the bottom to the top of drum 200, in some embodiments. In other embodiments, radius 107 may increase across the belt tiers from the bottom to the top of drum 200.

### Cage Bar Caps

Drum 200 may be rotated using any method known in the mechanical arts. In some embodiments, the spiral conveyor system may include a motor drive coupled to drum 200, either directly or through a transmission. The motor drive may be an electric motor, in some embodiments. In some embodiments, the motor drive is an internal combustion engine. Drum 200 comprises an internal structure (not shown) known in the art, such as a central shaft extending along a central longitudinal axis of rotation from which a plurality of supporting struts extend radially outward to support an outer skin or other structure to which the plurality of cage bars 213 are coupled. The outer skin may be a continuous surface in some embodiments or a discontinuous cage-like surface in other embodiments.

Cage bar caps 212 may have any shape to fit the drum structure. In some cases, the drum structure is made of metal flat bars or square tubing.

### Ribless Cage Drums

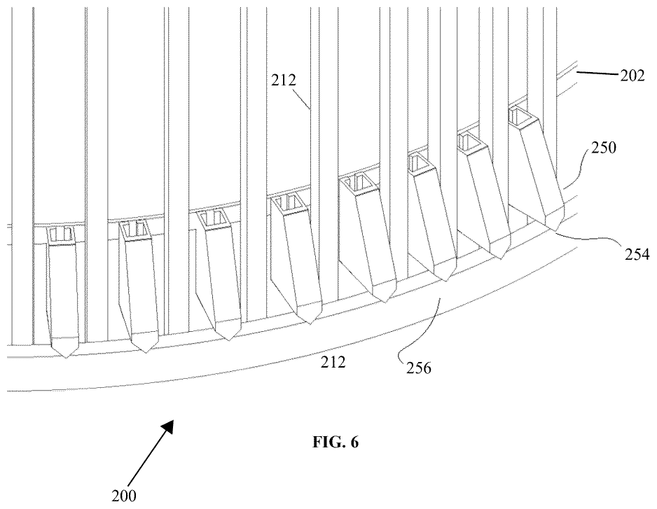

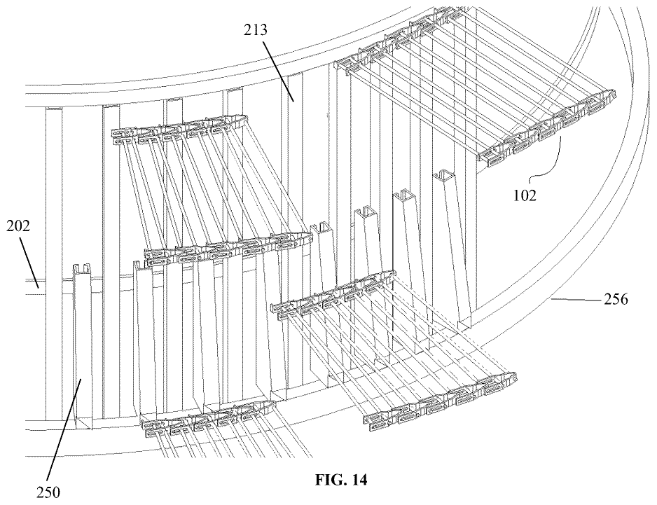

Cage drums are discussed herein above prior to introducing the detailed description of the drawing figures. FIG. 6-14 illustrate certain important elements of cage drums as described earlier herein. In some embodiments, cage drums comprise a transition element to facilitate onboarding, i.e., engagement of the belt 102 (see FIG. 14) with drum 200 at the infeed; and offboarding, i.e., disengagement of belt 102 from drum 200 at the outfeed. In some embodiments, as shown in the various drawing figures herein, onboarding occurs at a lower aspect of drum 200 for up running systems. For purposes of this disclosure, the term “lower” means closer to the lowest aspect of outer boundary 206 of drum 200 with reference to the floor or other drum supporting surface. “Upper” means closer to the uppermost aspect of outer boundary 206 of drum 200 with reference to the floor or other drum supporting surface. With this relationship in mind, in some embodiments of the system, the infeed is lower on the drum outer boundary than outfeed. Product resting on belt 102 will move upward along helical path 101 in these embodiments. An example of such an embodiment is shown in FIG. 5. In some embodiments, the infeed is higher on the drum outer boundary than the outfeed; i.e., the outfeed is lower than the infeed, wherein product resting on belt 102 moves downward along helical path 101 (not shown).

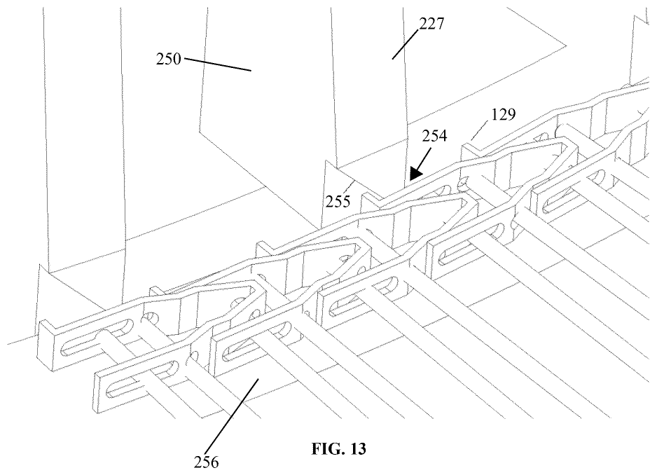

Belt engagement to the drum is facilitated by elements mounted at the drum outer boundary 206 to facilitate onboarding and offboarding of belt 102 components engaging and disengaging respectively with outer boundary 206, such as belt link tab 129 (see FIG. 13), in some embodiments. Consequently, the disclosed system comprises long cage bars, transition elements and an entrance ring and/or an exit ring, at points along drum outer boundary 206 vertically separated from one another to allow smooth onboarding of belt 102 at the infeed and, correspondingly, urging the belt away from cage 210 at the outfeed.

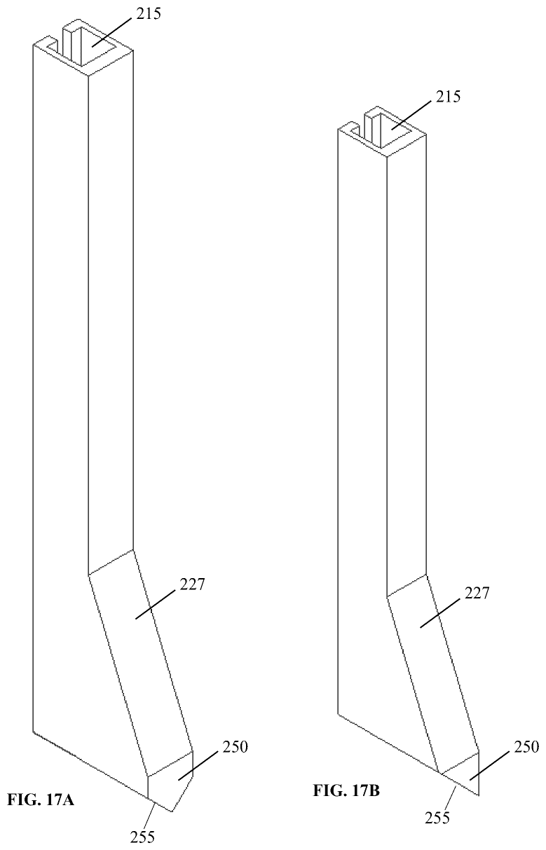

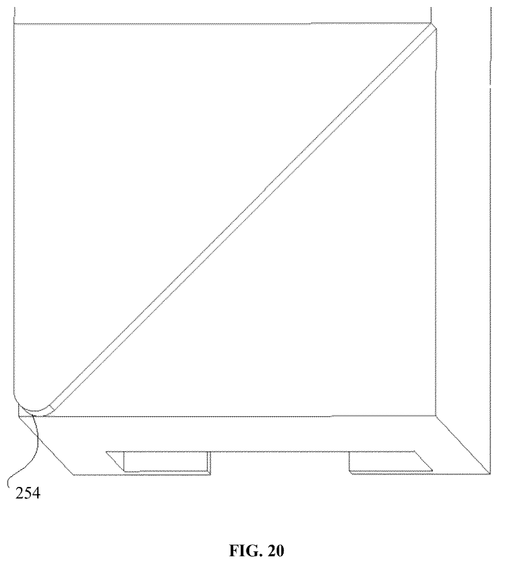

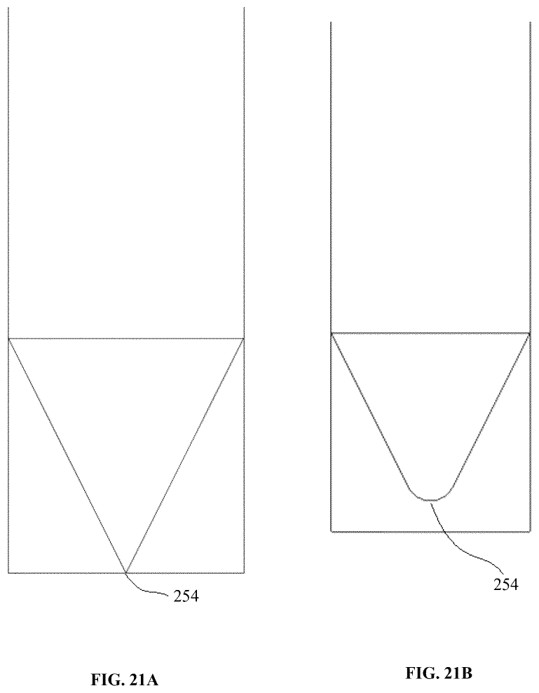

FIGS. 17A and 17B are perspective views of cage bar caps with pointed transition elements aligned to the long cap. In some embodiments, as shown in FIGS. 20 and 21, the end 254 of the transition element may be rounded. Also, in some embodiments, the drive element may be a one-piece component, that is the tapered portion and the straight portion may be part of the same single unitary piece of material. In other embodiments, two-piece components may be used where the tapered transition element is distinct from the longer cage bar cap. In such embodiments, the materials of the two components may be different than one another.

FIG. 17A shows a pointed transition element 250 having bar spacing 215 for mounting on a cage bar (not shown). In some embodiments, cage bar 213 may be formed as a transition element 250 and does not require coupling to an underlying cage bar 213. In some embodiments, including that shown in FIG. 17A, transition element 250 is coupled to cage bar 213. As shown in FIG. 17A, transition element 250 is formed with a ramp or tapered portion 227; i.e., not parallel with any other surface of element 250. Tapered portion 227 allows reduction of belt tension along belt inner edge 105 as belt 102 transitions onto drum outer boundary 206 formed at least in part by a plurality of transition elements 250. An end chamfer 255 may be formed on the end of transition element 250 to urge and facilitate engagement and/or disengagement of belt 102 with drum 200. In some embodiments, tapered portion 227 and chamfer 255 may be formed from cage bar 213 directly rather than cage bar cap 212. For example, in some embodiments of the system, there are no cage bar caps 212 and belt 102 interacts solely with the plurality of cage bars 210 at features formed by bars 212 (including, in some embodiments, tapered portions 227 and chamfers 255).

Many configurations of chamfer 255 are within the scope of the disclosures found herein. For example, in some embodiments, chamfer 255 may be machined on the leading face, trailing face (see FIG. 17b), or both (see FIG. 17A). In some embodiments the tapered portion may taper to a radius smaller than the drum 200 radius. In some embodiments, transition element 250 is formed entirely from a plastic polymer. In some embodiments, the plastic may be nylon or polyethylene. In some embodiments, transition element 250 is coupled directly to an entrance ring 256 (see FIG. 18). A plurality of transition elements 250 disposed around the periphery of drum 200 may be spaced at a distance equal to or slightly less than a compressed pitch at belt inner edge 105 to facilitate transfer of belt 102 from transition element 250 onto cage bar 212, in some embodiments. Further, in some embodiments, transition element 250 may engage with and drive belt 102 at a different link tab 129 than a different link tab 129 driven by an adjacent cage bar cap 212.

In some embodiments, any one or more of transition element 250, cage bar 213, and/or bar cap 212 presents a generally planar surface lacking any belt engagement features such as a groove, a rib, or other protrusion toward belt 102, and thus, may be considered to be “ribless.” In some embodiments, spacing between cage bars 213, bar caps 212, or other adjacent belt driving elements disposed on drum 200 and forming outer boundary 206 are configured to provide vertical support to belt 102. In some embodiments, belt 102 moving along helical path 101 upon drum 200 fitted with transition elements 250 may comprise tab 129 or other drum engagement feature wherein spacing between adjacent belt drive elements is increased by using one or more links lacking tab 129 or other element for engaging with drum 200.

FIG. 18 is a top cutaway view of an arc of a drum having pointed transition elements alternating with cage bar caps. FIG. 18 shows drum 200 having a plurality of cage bar caps 212 disposed around an arc at outer boundary 206 of drum 200 alternating 1:1 with a corresponding plurality of pointed transition elements 250. In some embodiments, pointed transition elements 250 are coupled to cage bars 213 at a bar couple 216. An entrance ring 256 is shown coupled to the plurality of transition elements 250 and an inner ring 202 is shown connecting the cage bars (not shown) around a circumference.

FIG. 6 is a perspective view of a drum having pointed and protruding transition elements alternating with cage bar caps. FIG. 6 shows drum 200 comprising a plurality of cage bar caps 212 disposed around an arc at outer boundary 206 of drum 200 alternating 1:1 with a corresponding plurality of pointed transition elements 250. The ratio between transition elements 250 and long cage bar caps 212 may vary with, for example, 2 transition elements in between the long caps or other ratio, or 2 long caps in between transition elements. Entrance ring 256 is shown coupled to the plurality of transition elements 250 in a position whereupon belt 102 reaches infeed 220 (not shown) and transitions into engagement with drum 200.

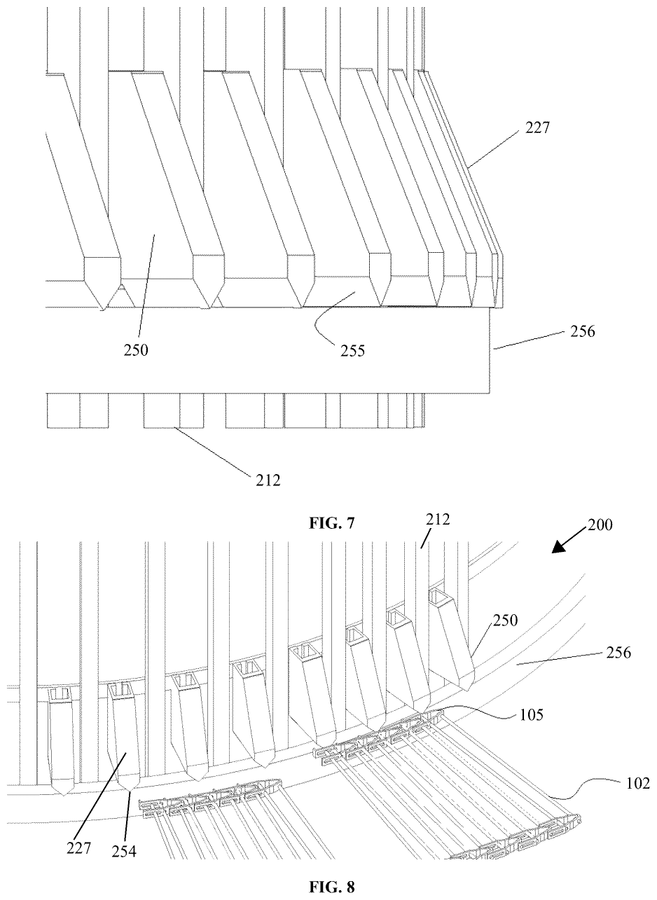

FIG. 7 is a side view of a drum having pointed transition elements alternating with cage bar caps. FIG. 7 shows a plurality of pointed transition elements 250 coupled to a corresponding plurality of cage bars 212 disposed around and forming outer boundary 206 (not shown in FIG. 7) of drum 200. FIG. 07 additionally shows entrance ring 256 coupled to the plurality of transition elements 250 which protrude from the ring outer face. Also shown are tapered portions 227 of transition elements 250. In some embodiments the pointed transition elements may be flush with the ring or even be withdrawn from the ring.

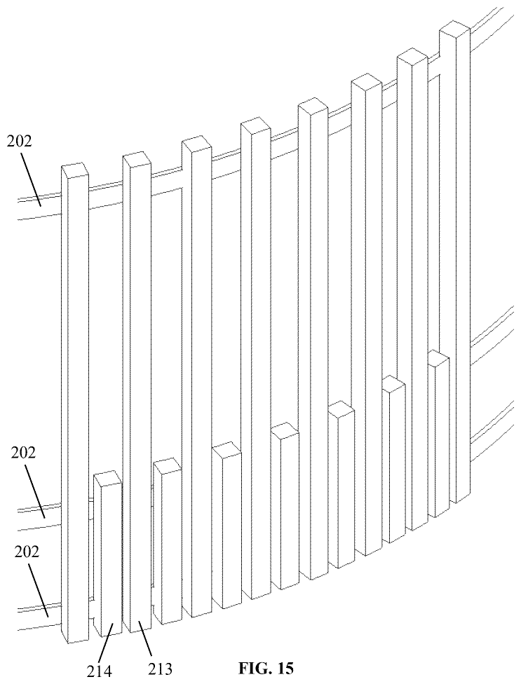

As shown on FIGS. 12, 14, and 15, cage drum 200 comprises an inner ring 202, in some embodiments. Inner ring 202 adds additional structural strength to a cage drum 200. In some embodiments, the plurality of transition elements 250 are coupled to and supported by inner rings 202 at their top, middle or bottom depending on the location and quantity of the cage rings. See FIG. 15 for an example of an embodiment with inner rings 202 at the top, middle, and bottom of the drum.

FIG. 10 is a perspective view of an arc of a drum having transition elements aligned to the long bar caps, in some embodiments this design may be formed monolithically out of metal without the necessity of caps. Entrance ring 256 is coupled to the plurality of transition elements 250 whereupon belt 102 (not shown) enters engagement with transition elements 250 across entrance ring 256. As the belt moves upward along helical path 101 (not shown) across outer boundary 206 of drum 200, belt inner edge 105 moves up or down depending on the configuration the plurality of tapered portions 227 and onto outer boundary 206 formed solely by the plurality of cage bars 213.

As shown in FIG. 10, tapered portion 227 reduces from a first radius 226 to a shorter, second radius 225. First radius 226 is defined as the linear distance from the transition element outermost face to the drum central longitudinal axis of rotation “A.” Second radius 225 is defined as the linear distance from front face of the ribless long cap to drum central longitudinal axis of rotation “A”. The tapered portion of the cap may protrude from, be flush with, or be withdrawn from the infeed ring 256.

FIG. 8 is a view of an arc of a drum having pointed transition elements alternating with cage bar caps and interacting with a belt. FIG. 8 shows drum 200 configured as a ribless cage drive having a plurality of long cage bar caps 212 alternating with transition elements 250 dispersed around the periphery of drum 200. Entrance ring 256 is coupled to the plurality of transition elements 250, as shown. In this example, and in some other embodiments, transition element 250 comprises both a transition portion 227 and a pointed bottom 254. For down running systems the transition elements may be at the top of the drum, just below the ring, with the pointed end turned up so the belt entering the system can engage and travel down the spiral path.

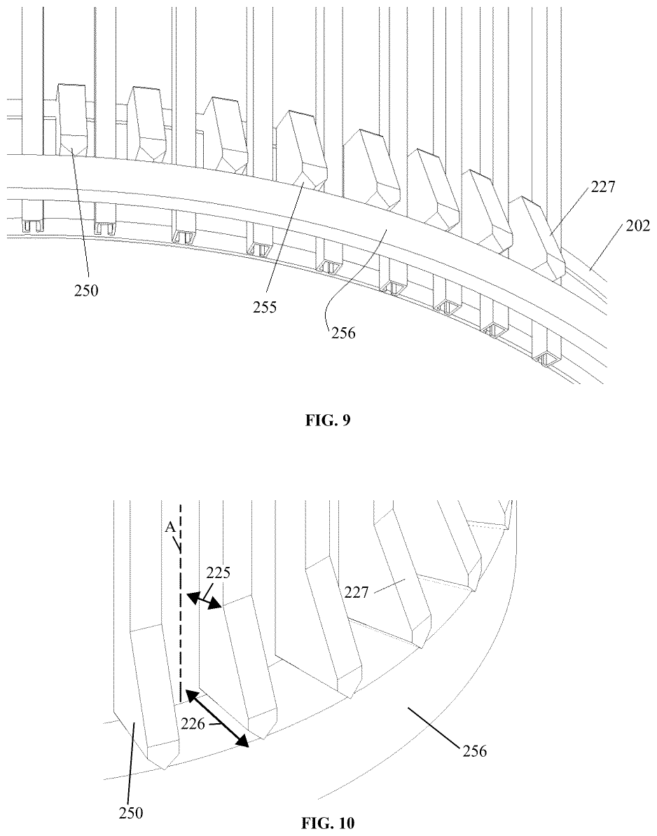

FIG. 9 is a perspective view of the bottom of the transition elements 250 which clearly shows the elements protruding from the ring face. In some embodiments the elements may be flush with or be withdrawn from the outer facing surface of ring 256.

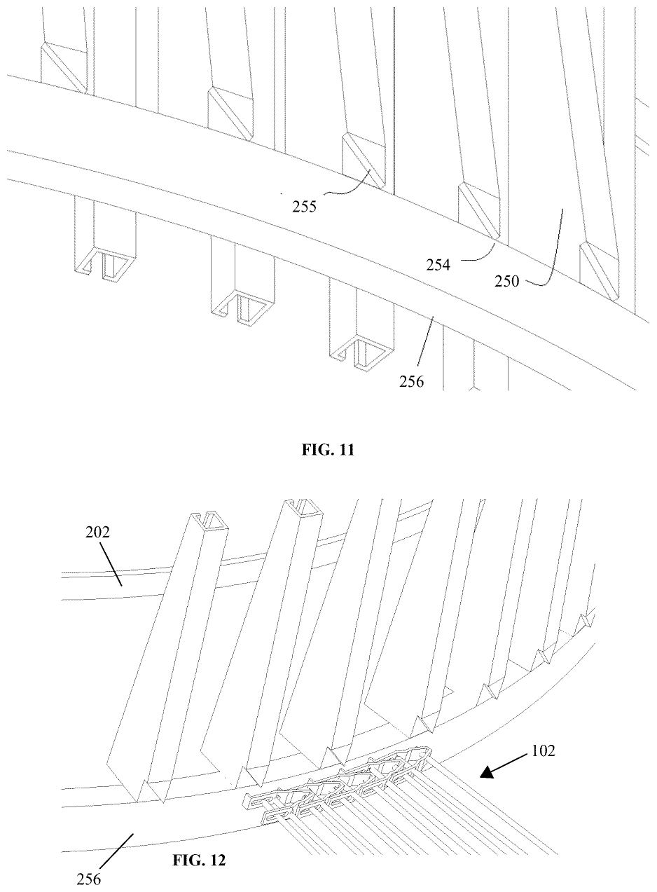

FIG. 11 is a perspective view showing a sharp pointed end of the transition element 250 protruding from the infeed ring 256.

FIG. 2 is a perspective view of prior art of an arc of a drum having alternating ribless transition elements, long cage bars and an entrance ring. FIG. 2 shows drum 200 comprising a plurality of parallel ribless transition elements 250 alternating between adjacent cage bar caps 212. Entrance ring 256 is also shown coupled to a lower aspect of the plurality of transition elements 250. The tabs of the belt link onboarding the spiral while leaving the ring may contact the front face of the transition elements. Since they are not pointed or protruding, a non-smooth belt displacement may happen until final engagement is reached.

FIG. 13 is a perspective view of a segment of belt comprising U-shaped links engaged on a pointed end 254 of the transition element. FIG. 13 shows drum 200 comprising a plurality of parallel pointed transition elements 250 which are protruding from the outer facing surface of ring 256. Tabs 129 disposed on U-links are driven by the chamfer 255 of the pointed transition elements 250 coupled to alternating cage bar caps 212, as shown. It will be understood that the chamfer may incline forwards in some embodiments, as shown in FIG. 13, or backwards in other embodiments. The transition elements 250 hold drum engagement features-tabs 129, in this example-out and away from cage bar caps 212 (or cage bars 213). As belt passes along helical path 101 upwards across transition elements 250, tabs 129 (or other belt engagement feature) move inwards up tapered portion 227 until drive drum 200 engagement of tabs 129 transfers from transition elements 250 to cage bars 213 (or bar caps 212), in some embodiments.

FIG. 15 is a perspective view of the drum metal structure composed of inner rings 202, short cage bars 214, and long cage bars 213. Pointed and tapered transition elements 250 may be fixed to the short cage bars 214 while long cage bar caps 212 are connected to long cage bars 213. In some embodiments, the drum structure may not have a short cage bar in between. In this case, the tapered transition element and the long bar cap are aligned and fixed directly onto the long cage bar.

FIG. 14 is a perspective view of the drum and the belt along different levels on the spiral path showing at the bottom the initial engagement to the pointed transition element then the pointed transition element driving the belt with its leading face, after that the belt transferred to engage the long cap drive face and the belt finally leaving the caps to the outfeed.

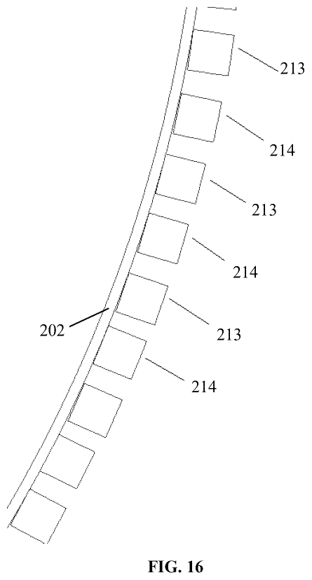

FIG. 16 is a top view of the cage structure composed of short cage bars 214 and long cage bars 213 alternating 1:1 and the inner ring 202.

Components of spiral belt system 100 are formed from suitable materials known in the art, without limitation. For example, drum 200, belt 102, and the listed components comprising drum 200 and belt 102 may be formed from metals such as steel, stainless steel, aluminum, and other metal alloys. In some embodiments, these components may be formed from thermostable plastics and other polymers known in the art. In some embodiments, a combination of metals, metal alloys, and plastic polymers are used. Because the disclosed spiral conveyor system is intended to be used in a wide range of industrial applications, multiple materials and combinations of components made from different materials is within the scope of the disclosures and teachings herein.

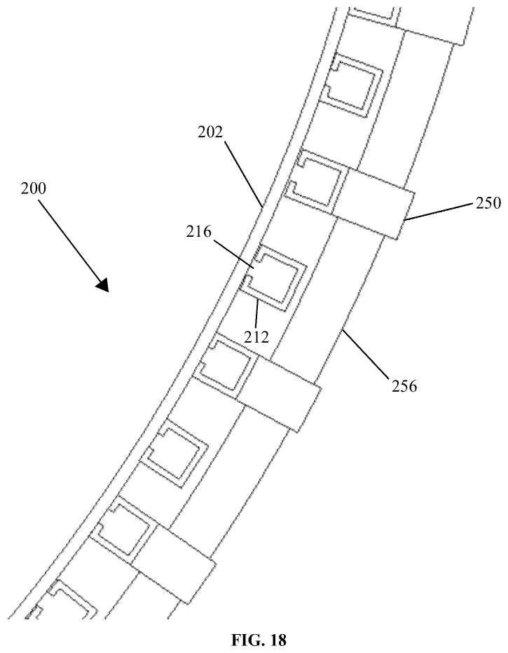

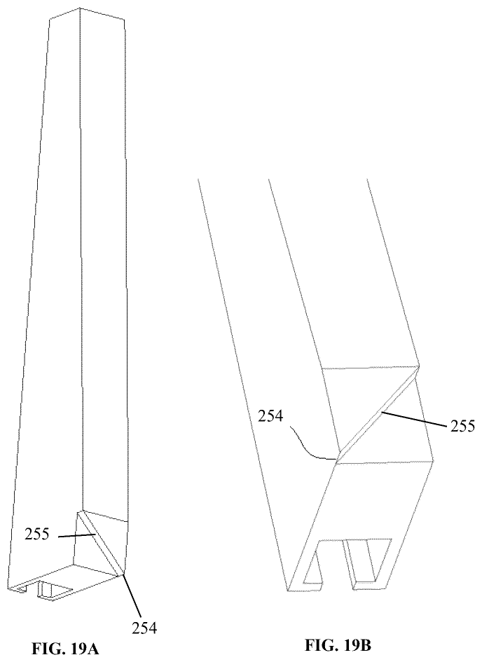

FIG. 19A is an enlarged view of the end of the pointed transition element with a sharp end, chamfer 255 leading backwards. FIG. 19B shows a similar transition element with a chamfer 255 leading forwards.

FIG. 20 is a view of a transition element including a rounded end 254.

FIG. 21A is a front view of a transition element having a sharp pointed end 254. FIG. 21B is a front view of a transition element having a rounded end 254.

FIG. 22 is a view of the belt tab interacting with the end of the transition element 250. As shown in FIG. 22, belt tab 129 may have a rounded and smooth top so the link can slide across the pointed end for engagement at the chamfer face.

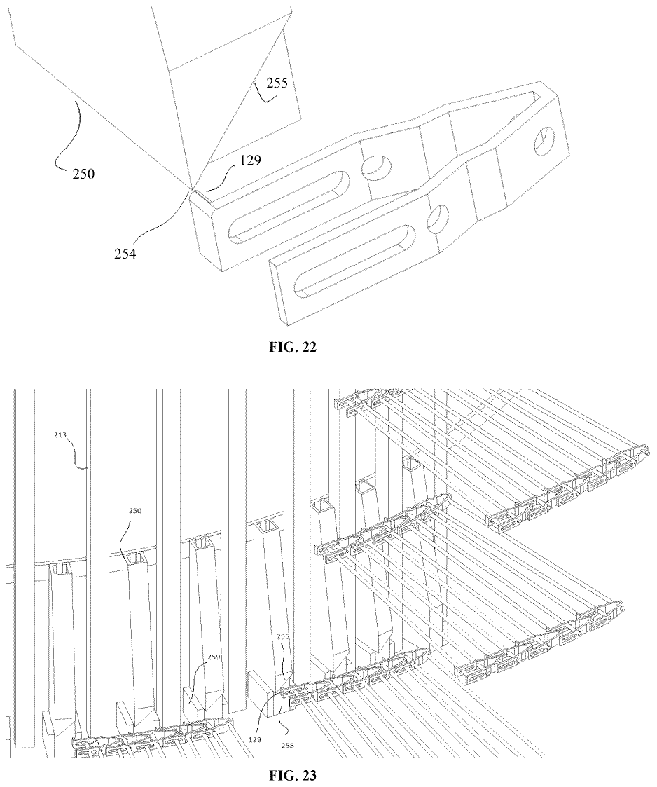

FIG. 23 is a view of the embodiment which does not require an infeed ring, the transition elements have a supporting face 258 that may be connected to one or two attachment plates 259 to increase the supporting face width, two belt edge features 129 are supported by the face 258 and by the attachment plates 259 so the belt collapses, and meanwhile direct engagement is avoided. As the belt travels its helical path, the supporting face gets narrower (smaller than the belt compressed pitch) so the belt can engage at the designed height. The width of the transition element face 258 plus the width of the attachment plates 259 must be wider than the belt collapsed pitch at this diameter location so at least two edge features are supported. The attachment plates may be made of the same material or different material than the transition elements. The attachment plates may be bolted to the transition elements or riveted. It will be understood that other methods of fixation may also be used to connect these components. FIG. 23 also shows belt sections on several locations along the drum height.

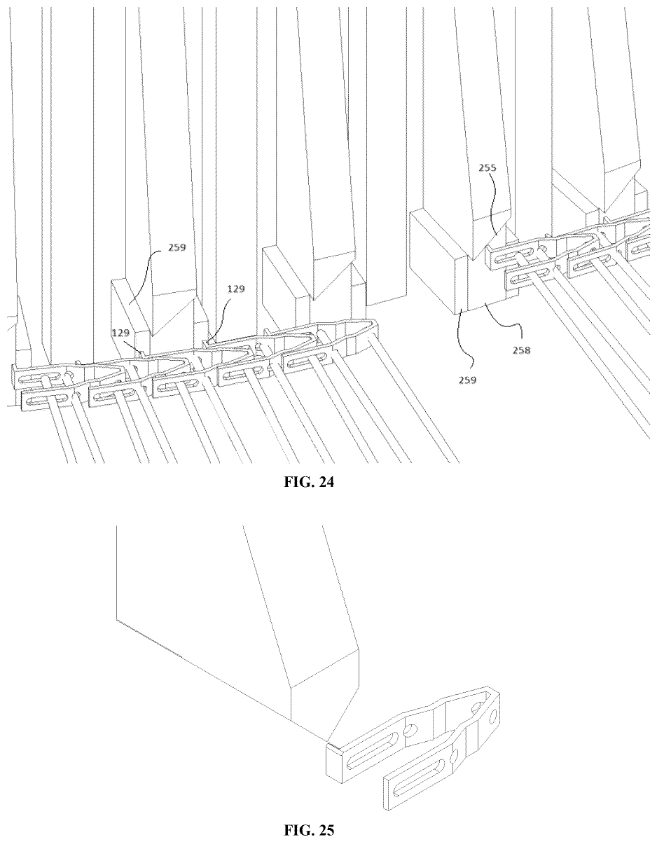

FIG. 24 is an amplified view of the belt interacting with transition elements, attachment plates, and other components. The transition elements shown are parallel to the long cage bar caps. In some embodiments, these transitions elements may be aligned to the long cage bar caps. In some embodiments, the attachment plates 259 may be replaced by a monolithic tapered transition element in which the base is wider than the top so the belt can be correctly supported before engagement to the leading face of the transition element. In some embodiments, the wider supporting face composed of face 258 and plates 259 for belt collapse may be a monolithic block separated from the pointed transition element.

FIG. 25 is a view of the interaction between a belt tab and a symmetrical pointed transition element which is formed by chamfers at the trailing and leading edges. In some embodiments, the end of the transition element may be asymmetrical.

The embodiments and examples set forth herein were presented in order to best explain the present invention and its practical application, and to thereby enable those of ordinary skill in the art to make and use the invention. However, those of ordinary skill in the art will recognize that the foregoing description and examples have been presented for the purpose of illustration and example. The description as set forth is not intended to be exhaustive or to limit the invention to the precise form disclosed. Many modifications and variations are possible, in light of the teachings herein above.

What is claimed is:

1. A spiral conveyor system, comprising:
a conveyor belt formed of a plurality of links joined by a plurality of connecting rods forming a plurality of belt segments;
a drum formed generally as a cylinder having a central longitudinal axis coaxial, the drum defining a helical path for the conveyor belt and an outer boundary, wherein the drum is configured to rotate around the central longitudinal axis and to releasably interact with each of the plurality of belt segments at the outer boundary;
wherein the belt moves along the helical path in response to the sequential interaction between the drum outer boundary and the belt segments as the drum rotates;
the drum including a plurality of tapered transition elements configured to facilitate engagement of the belt with the drum.

2. The system of claim 1, wherein the drum sequentially interacts with the belt segments by mechanical engagement with a rod inner end or a link tab.

3. The system of claim 2, wherein the drum has an infeed ring for belt inner edge collapsing.

4. The system of claim 1, wherein the transition element is ribless.

5. The system of claim 1, wherein the tapered transition elements are aligned to a plurality of cage bar caps forming the drum.

6. The system of claim 1, wherein the drum includes a plurality of drive elements, wherein each drive element is formed monolithically together with a tapered transition element as a single unitary piece of material.

7. The system of claim 1, wherein the tapered transition elements are arranged parallel to a plurality of cage bar caps forming the drum.

8. The system of claim 7, wherein the ratio between long caps and transition elements is 1:1.

9. The system of claim 7, wherein the ratio between long caps and transition elements is different than 1:1.

10. The system of claim 1, wherein the tapered transition elements have pointed ends.

11. The system of claim 1, wherein the tapered transition elements have rounded ends.

12. The system of claim 1, wherein the tapered transition elements have rearward facing chamfers.

13. The system of claim 1, wherein the tapered transition elements have forward facing chamfers.

14. The system of claim 3, wherein the transition elements protrude from an outer facing surface of the infeed ring.

15. The system of claim 3, wherein the transition elements are withdrawn from an outer facing surface of the infeed ring.

16. The system of claim 3, wherein the transition elements are flush with an outer facing surface of the infeed ring.

17. The spiral conveyor system of claim 1, further including a plurality of cage bar caps; and
wherein the cage bar caps and transition elements are ribless.

18. The spiral conveyor system of claim 1, further including a plurality of long cage bars and a plurality of short cage bars;
wherein the transition elements are attached to the short cage bars.

19. The spiral conveyor system of claim 3, wherein the transition elements are attached to the infeed ring.

20. The system of claim 1, wherein the drum further comprises:
an infeed and an outfeed, wherein the infeed and the outfeed are disposed on the outer boundary at separate axial locations, wherein the interaction between the drum and the segments occurs along a length of the drum central longitudinal axis beginning at the infeed and terminating at the outfeed;
a first radius between projecting from the longitudinal axis to the outer boundary between the infeed and the outfeed;
a second radius projecting from the longitudinal axis to the outer boundary at one or both of the infeed and the outfeed; and
the transition element including a tapered portion disposed on the outer boundary, wherein the second radius is greater than the first radius, the second radius transitions to the first radius along the tapered portion, and wherein the ramp is configured to move the belt inward from the second radius to the first radius beginning at the infeed and outward from the first radius to the second radius ending at the outfeed.
